(19) United States
(12) Patent Application Publication
(10) Pub. No.: US 2011/0068017 A1
(43) Pub. Date: Mar. 24, 2011

(54) Kit For, And Method Of Creating, Three-Dimensional Wall Murals

(76) Inventor: Lisa Feldman, Wellington, FL (US)

(21) Appl. No.: 12/887,486

(22) Filed: Sep. 21, 2010

Related U.S. Application Data
(60) Provisional application No. 61/244,429, filed on Sep. 21, 2009.

(51) Int. Cl. B44D 3/00

(52) U.S. Cl. 206/1.7

(57) ABSTRACT

A kit and method of creating a three-dimensional murals that can be modified over time. A wall mountable sheet, such as wallpaper or canvas, contains a background with a general artistic theme. The artist builds on the background and personalizes it to reflect individual interests. A collection of ornamental items is included in the kit and provides the three-dimensional aspect to the mural. The ornamental items may include any number of items, such as beads, ribbons, buttons, rhinestones, photos, etc. In addition, any other object that may be pleasing or relevant to the artist, including photographs, can be incorporated by the artist when first creating the mural, or over time as events occur in the artist's life. The additional items can be in the kit, or obtained from any suitable source. The kit further includes adhesive for securing objects to the wall mountable sheet.

### CROSS-REFERENCE TO RELATED APPLICATIONS

This application is related to, and claims the benefit of, the provisional patent application entitled “A Kit For, And Method Of Creating, Three-Dimensional Wall Murals”, filed Sep. 21, 2009, bearing U.S. Ser. No. 61/244,429 and naming Dr. Lisa Feldman, the named inventor herein, as sole inventor, the contents of which is specifically incorporated by reference herein in its entirety.

### BACKGROUND

1. Technical Field

This invention relates in general to wall decorations, and more particularly it relates to a kit for, and a method of, creating three-dimensional wall murals to decorate interior walls of a building.

2. Background of the Invention

The interior walls of most buildings, both residential and commercial, are typically adorned with some form of ornamentation, such as photographs or paintings that are suspended on the wall. While the artwork secured to the wall will reflect the owner's taste, it is typically impersonal in nature and does not reflect the personality or interests of the owner. It would be desirable to have a method of decorating a wall that reflects the owner or occupant in a personal way.

Another type of wall ornamentation is the mural. Murals are typically custom works of art that can be designed to more closely reflect the tastes, interests, and personal details related to the owner. However, murals present several significant drawbacks. First, they require an artist with sufficient talent to properly create the desired image. As a result, most individuals would not have the artistic talent to create a pleasing wall mural for their home or office. Due to this, it would not be possible for most individuals to paint their own conventional wall mural. It would be desirable to have a method of creating a wall mural that did not require a substantial amount of artistic talent on the part of the individual creating the mural.

A second drawback associated with conventional wall murals is that they typically are two-dimensional in nature. While a high quality mural may be very pleasing, the flat nature of the work lacks the presence of a three-dimensional work that would provide a sculpted feel to the artwork. It would be desirable to have a method of creating three-dimensional murals that provide the artistic benefits of a conventional mural along with the artistic benefits of a sculpture.

A third drawback to conventional murals is that they typically represent a fixed point in time. While this is desirable for certain purposes, would also be desirable to have a method of creating a mural that can evolve over time to tell a story, and/or record new events.

While the prior art has provided a number of pleasing wall decorations, including murals, it has failed to provide a method of creating a mural that can be installed by an individual having minimal artistic talent, can be three-dimensional nature to incorporate sculptural artistic aspects, and can be modified over time to tell a individual story, or recount events in an individual's or a family's life.

### SUMMARY OF THE INVENTION

This invention provides a method of creating a three-dimensional mural that can be modified over time by individuals having a minimal level of skill. The invention provides a kit with a wall mountable sheet such as wallpaper or canvas. The wall mountable sheet contains a background sketch that the artist builds on and personalizes to reflect an individual's interests, an individual's story, a family's story, etc. A collection of ornamental objects is included that provide the three-dimensional aspect to the mural. The ornamental objects may include any number of items, such as beads, ribbons, buttons, rhinestones, photos, etc. In addition, any other object that may be pleasing or relevant to the artist can be incorporated by the artist when first creating the mural, or over time as events occur in the artist's life. The additional objects can be in the kit, or obtained from any suitable source. The kit further includes adhesive for securing objects to the wall mountable sheet.

### BRIEF DESCRIPTION OF THE DRAWINGS

FIG. 1 is a front view of a preferred embodiment of the invention that shows a completed three-dimensional mural installed on a wall.

FIG. 2 is a close-up detail view of a preferred embodiment of the invention that illustrates a detail of the three-dimensional mural in which a portion of shoes printed in the background are adorned with three-dimensional bow ornaments.

FIG. 3 is a close-up detail view of a preferred embodiment of the invention that illustrates a detail of the three-dimensional mural in which a table printed in the background is adorned with a three-dimensional lipstick that is adhered to the surface of the table.

FIG. 4 is a close-up detail view of a preferred embodiment of the invention that illustrates a detail of the three-dimensional mural in which a purse printed in the background is adorned with photographs.

FIG. 5 is a close-up detail view of a preferred embodiment of the invention that illustrates a detail of the three-dimensional mural in which a feather boa adorns a jacket that is printed on the background.

FIG. 6 is a close-up detail view of a preferred embodiment of the invention that illustrates a detail of the three-dimensional mural in which mirrors adorn a table edge that is printed in the background, and a variety of gemstones and jewelry are secured to the background.

FIG. 7 illustrates a front view of an alternative preferred embodiment that shows a simpler mural that shows two girls in the background. The mural is decorated with items selected by the individual living in the room to personalize the mural.

### DETAILED DESCRIPTION OF THE PREFERRED EMBODIMENT

Prior to a discussion of the figures, an overview of the invention will be presented. The invention provides a kit that allows an individual with limited artistic talent to create a customized and personalized three-dimensional wall murals that can reflect a single point in time, or tell a story that evolves over time.

Another optional feature of the invention is that it can use one or more preprinted base drawings supplied by the kit, or the individual can independently select an alternative background by using a commercially available wallpaper, poster, print, etc. Further, the individual can even paint the background and adorn it with material from the kit or other items.

Another feature of the invention provides for modification of the mural over time. For example, a mural in a child's room can have a number of incomplete sections for unknown events that will occur in the future. Incomplete sections can include places for photographs, places for three-dimensional items related to the child's interest, places related to hobbies, schools, family trees, vacations, graduations, etc.

An advantage of the invention is that it allows an individual with limited artistic talent to take the background sheet with a relatively simple structure and embellish that background such that a portion of the wall, or an entire wall can be gradually expanded into a three-dimensional work of art that is personalized for that person, or that family.

The items included in the kit can vary based on the type of project an individual is working on. For example, a kit designed for use in a young girl's room may include ribbons, artificial flowers, rhinestones or other faux gems, feathers, etc. Likewise, a kit for a boy's room might have sports items, dinosaurs, etc. The contents of the kit would also vary in relation to the age of the child. Obviously, a teenage girl would have far different interests than five-year-old boy in terms of what they want for decoration in their rooms. However, an advantage of the invention is that it can be used with any type of theme that is suitable for a given age or gender.

In edition to use in a residential setting, the invention can also be used in commercial settings. For example, a merchant or professional might want to use a three-dimensional wall mural that relates to the business. A building contractor may wish to install a mural in a waiting room or conference room that illustrates current or past projects. Dentists or physicians may wish to provide some entertaining work or educational information in a pleasant and artistic fashion. The kit provides an easy way for any business to convey information in an entertaining fashion.

In addition to the initial kit that would have a basic set of decorative items, additional items may be made available separately and be provided as optional add-ons to the kit. For example, smaller kits that relate to a particular theme or item, such as a makeup theme for girls, a racecar theme for boys, etc., such that the mural can be modified over time as tastes change or as the individual grows. This is an advantage for the individual because they to not have to pre-purchase material that they may not want to use for years to come.

Having discussed the invention in general, we turn now to a detailed discussion of the drawings.

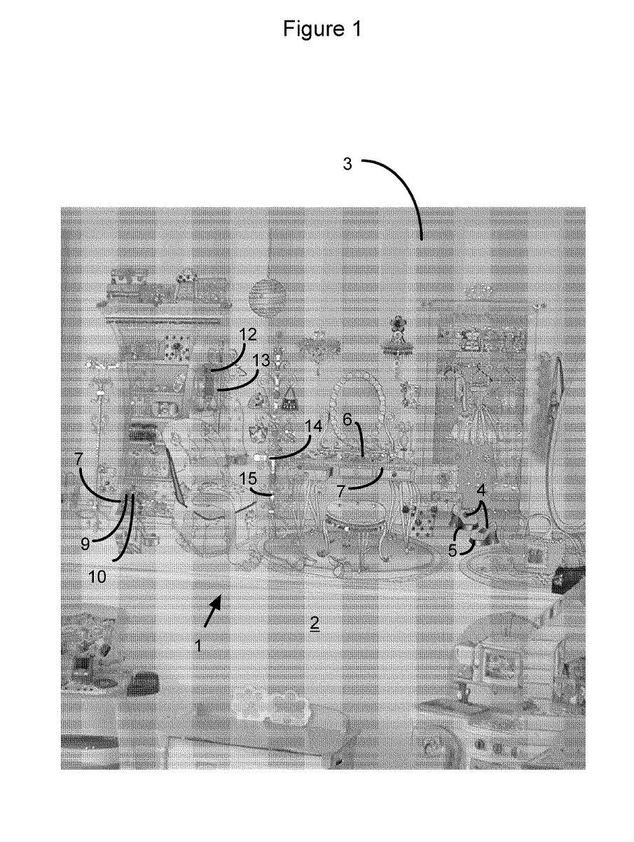

FIG. 1 is a front view of a preferred embodiment of the invention that shows a completed three-dimensional mural 1 installed on a wall 2. The three-dimensional mural 1 consists of a base drawing 3 that provides a background for the three-dimensional mural 1. The base drawing 3 can be secured to the wall by any convenient means, such as adhesives, self-stick backings, etc. The base drawing 3 provides a background sketch upon which the three-dimensional portion the mural is built. The base drawing 3 provides outlines of the mural so that someone having limited artistic talent can bild on the base drawing 3 to produce a unique mural that incorporates many aspects that are personal to the artist.

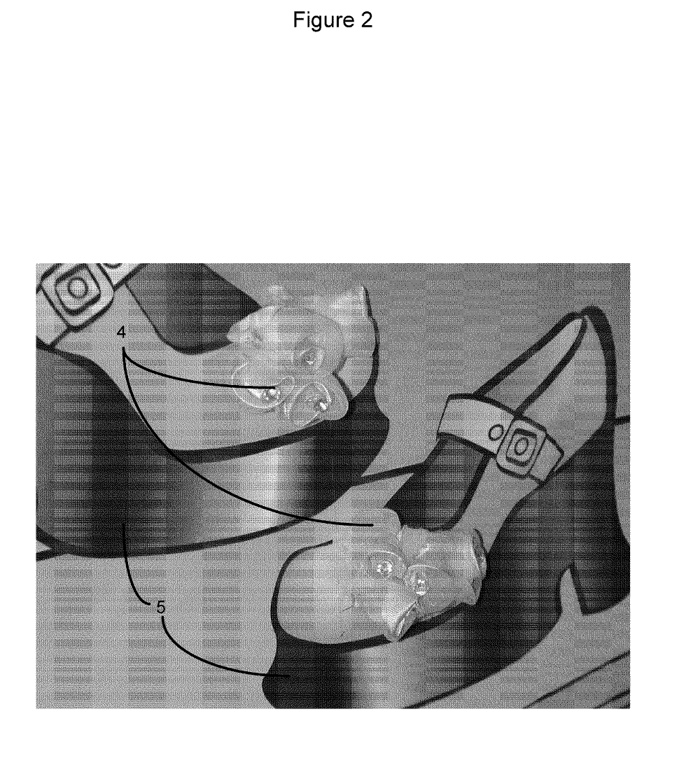

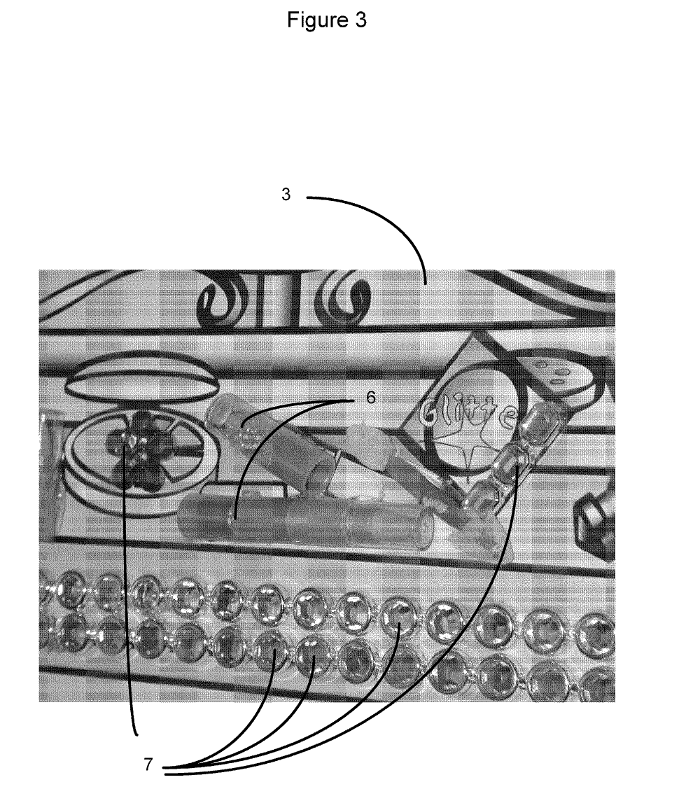

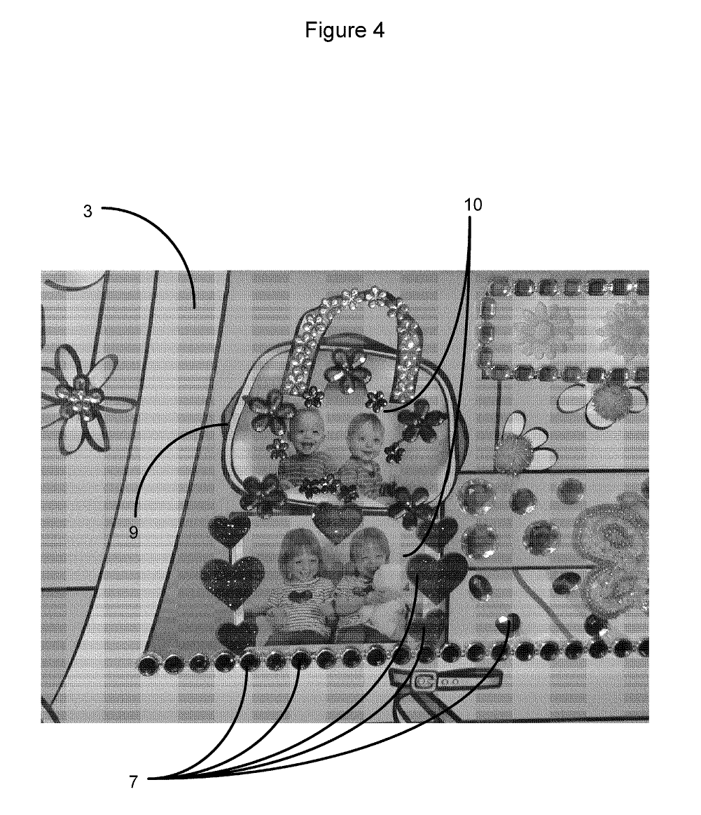

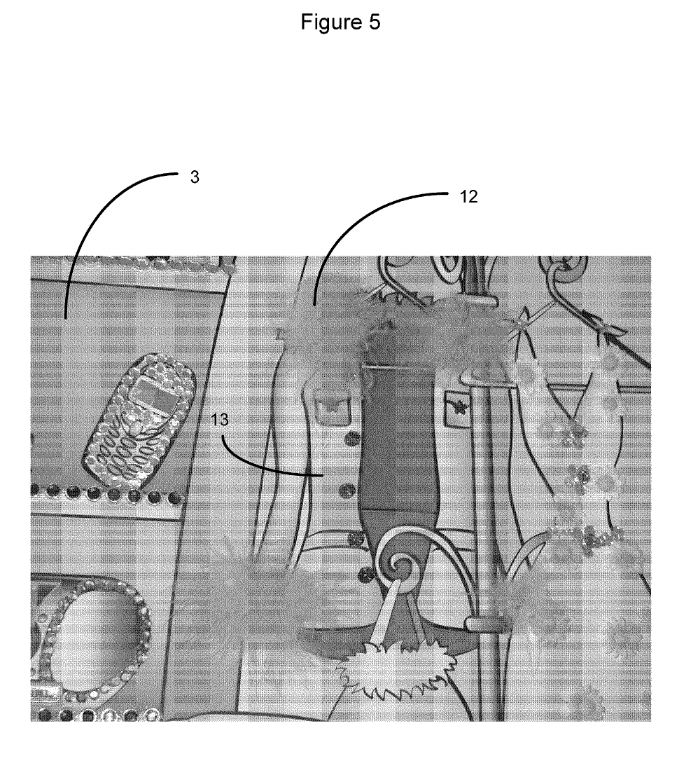

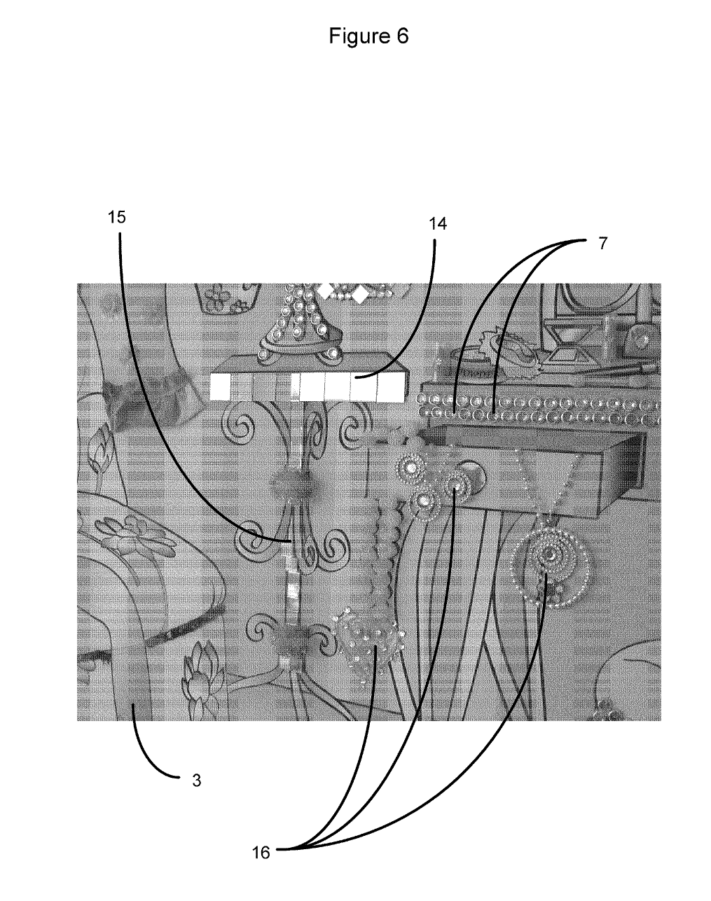

By way of example, this mural in FIG. 1 illustrates how a wall can be decorated for a young girl. The three-dimensional aspects of this mural include ornamental bows 4 secured to shoes 5 which are part of the base drawing 3. The ornamental bows 4 and shoes 5 are illustrated in greater detail in FIG. 2. Likewise, a lipstick 6 and gemstones 7 are illustrated as ornaments on a table 8 that is part of base drawing 3. Lipstick 6 and gemstones 7 are illustrated in greater detail in FIG. 3. Also shown in this figure are photographs 10 secured to purse 9 on base drawing 3. Photographs 10 and gemstones 7 are illustrated in greater detail in FIG. 4. FIG. 5 also illustrates garment 11 that is part of the base drawing 3. Garment 11 is adorned with a feather boa 12 that is secured to garment 11. Garment 11 and feather boa 12 are discussed in greater detail in regard to FIG. 5. Side table 13 is part of base drawing 3 and is adorned with mirrors 14 and other objects. Side table 13 is discussed in greater detail in regard to FIG. 6. An advantage provided by the invention is that the base drawing 3 provides a general outline with open space that allows an individual to be creative. The kit provides a variety of accessories, such as bows, ribbons, mirrors, gemstones, feathers, etc., so that an individual can create and customize a three-dimensional mural 1 such that it becomes a unique work of art and/or wall sculpture.

Another significant advantage of the invention is that it allows an individual to further customize the three-dimensional mural 1 by adding personal items that are not included in the kit. The addition of personal items allows the individual to create a work of art that is truly unique. For example, the addition of photographs showing important events in an individual's life, members of the family tree, family gatherings, etc., add a unique dimension to the three-dimensional mural 1. In addition, an advantage provided by the invention is that the three-dimensional mural 1 does not have to be completed immediately. Portions can be added at later times to track the history of an event or family over time.

FIG. 2 is a close-up detail view of the preferred embodiment of FIG. 1 that illustrates a detail of the three-dimensional mural 1 in which a portion of shoes 5 printed on base drawing 3 are adorned with three-dimensional ornamental bows 4. While a substantial portion of the artwork layout is provided by base drawing 3, the addition of actual bows 4 adds a three-dimensional character to the shoes 5 that catches the eye and gives the shoes 5 a three-dimensional quality.

FIG. 3 is a close-up detail view of the preferred embodiment of FIG. 1 that illustrates a detail of the three-dimensional mural 1 in which a table 8 printed in the base drawing 3 is adorned with a lipstick 7 that is adhered to the surface of the table 8. Proper placement of the lipstick 7 makes it appear as if it is actually resting on the table. Also shown in this figure are a variety of gemstones 7 that enhances the three-dimensional quality of the three-dimensional mural 1.

FIG. 4 is a close-up detail view of the preferred embodiment of FIG. 1 that illustrates a detail of the three-dimensional mural in which a purse 9 printed on the base drawing 3. The purse is adorned with photographs 10. Also shown in this figure are a variety of gemstones 7 that are secured to the base drawing 3. As can be seen from this figure, the ability to attach photographs 10 to base drawing 3 allows an individual to create a unique and custom mural. Further, even if an identical kit was purchased by another individual, the three-dimensional mural 1 will vary from one installation to another because of the different choices made when applying three-dimensional ornamental items from the kit to the base drawing 3, and the attachment of personal articles that are unique to the artist.

FIG. 5 is a close-up detail view of the preferred embodiment of FIG. 1 that illustrates a detail view of the three-dimensional mural 1 in which a feather boa 12 adorns a jacket 13 that is printed on the base drawing 3.

FIG. 6 is a close-up detail view of the preferred embodiment of FIG. 1 that illustrates a detail view of the three-dimensional mural 1 in which mirrors 14 adorn the edge a lamp table 15 that is printed in the base drawing 3. In addition, a variety of gemstones 7 and jewelry 16 are secured to the base drawing 3.

The foregoing figures provide an example of the wide variety of ornamental items that can be used when creating a three-dimensional mural 1.

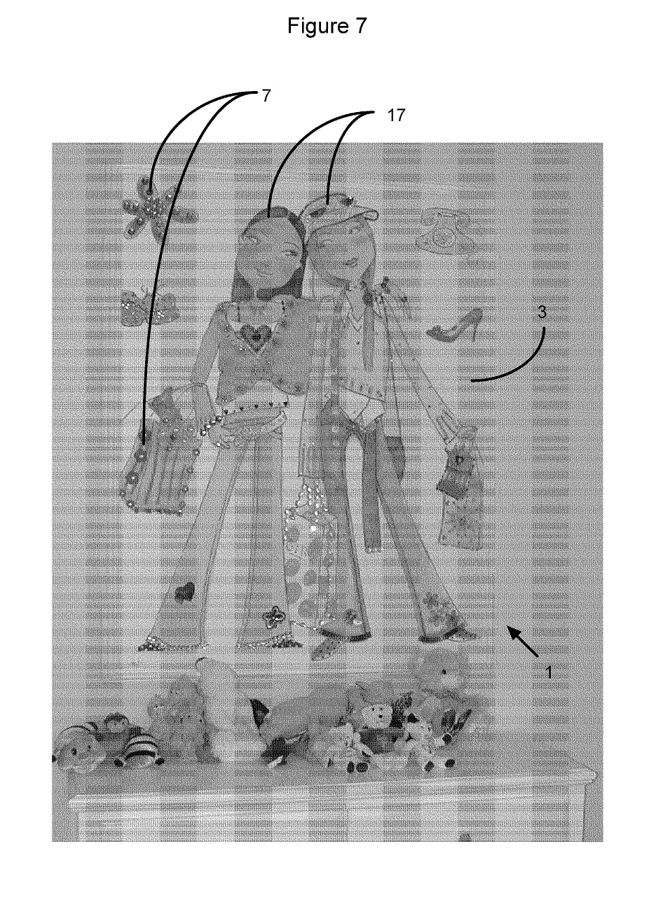

FIG. 7 illustrates a front view of an alternative preferred embodiment in which two girls are printed on the base drawing 3. The mural is decorated with items selected by the individual living in the room to personalize the mural. This figure illustrates the fact that the base drawing 3 would be selected based on the age and personality of the person living in that room. An advantage of the invention is that it provides an entertaining mural for any age, young or old. Further, the embodiments illustrated herein describe the type of mural used in residential settings. Those skilled in the art will recognize that any commercial establishment could also benefit from the features and advantages of the invention. For example, a dentist's office or pediatrician's office may have murals related to those specialties and which may appeal to patients of any age.

For illustrative purposes, sample murals were illustrated which could be produced with the kit used by the invention. However, there is no limit to the variety of murals that can be created using the kit. Numerous decorative items, such as gemstones, feathers, tiles, mirrors, pieces of wood, etc. can be included in the kit to provide a user with a broad range of options. In addition, the number of personal items that an individual can add is unlimited. As a result, a three-dimensional mural 1 produced by the invention provides not only a broad range of choices, but it further allows individuals to create one-of-a-kind art by adding their own unique personal items.

In the preferred embodiment, the kit includes one or more base drawings 3. The base drawings 3 can be unique artwork, commercially available canvases, commercially available wallpapers, or any other image that can be secured to a wall. As a result, there is no limit to the number of base drawings 3 that can be used with the invention. The kit can be sold with or without the optional base drawings. Likewise, after completing the first mural, an individual may obtain additional base drawings 3 so that a second mural can be created using material from the kit.

Optionally, a frame can be placed around the mural to create the illusion that it is hung on the wall in the manner of a painting. Frame sections can also be included as part of the kit. It is the intent to provide kits with varying components that suit an artist's needs. For example, kits may be provided with or without frames, they may be provided with items specific to certain genders or ages, kits may be provided with items which are specific to certain themes such as outer space or the frontier west, etc., the base drawings 3 can vary. As a result, the kit user can select the kit that is most appropriate for them and most appropriate for where is it going.

While specific embodiments have been discussed to illustrate the invention, it will be understood by those skilled in the art that variations in the embodiments can be made without departing from the spirit of the invention. For example, a wide variety of materials can be used as a canvas for the base of the mural. Likewise, almost any material can be used to decorate the mural. Therefore, the invention shall be limited solely to the scope of the claims.

I claim:

1. A three-dimensional mural kit comprising:
at least one base drawing;
means to secure the base drawing to a surface;
a plurality three-dimensional ornamental items;
means to secure the three-dimensional items to the base drawing;
whereby the base drawing in combination with the plurality of three-dimensional ornamental items form a three-dimensional mural.
